(19) United States
(12) Patent Application Publication
(10) Pub. No.: US 2024/0327696 A1
(43) Pub. Date: Oct. 3, 2024

(54) ANTIFOULANT FOR REFINERY APPLICATIONS

(71) Applicant: Ecolab USA Inc., St. Paul, MN (US)

(72) Inventors: Omer GUL, Rosenberg, TX (US); Abuzar SYED, Richmond, TX (US)

(73) Assignee: Ecolab USA Inc., St. Paul, MN (US)

(21) Appl. No.: 18/611,076

(22) Filed: Mar. 20, 2024

Related U.S. Application Data
(60) Provisional application No. 63/493,690, filed on Mar. 31, 2023.

(51) Int. Cl. C09K 8/524

(52) U.S. Cl. CPC C09K 8/524

(57) ABSTRACT

Antifoulant compositions and methods of using the compositions to control fouling are provided herein. The compositions may be added to a medium, such as crude oil or a crude oil fraction. The medium may include a foulant, such as an asphaltene, and the compositions and methods provided herein are capable of dispersing the foulant, such that fouling of equipment in connection with the medium is controlled.

### TECHNICAL FIELD

The present disclosure generally relates to antifoulant compositions and methods of controlling fouling using the compositions.

### BACKGROUND

Asphalts and asphaltenes may be present in crude oils. These materials have been defined as dark brown to black cementitious materials in which the predominating constituents are bitumens that occur in nature or which are obtained in the processing of petroleum and crude oils. These materials characteristically contain very high molecular weight hydrocarbons, sometimes referred to as asphaltenes, and are essentially soluble in carbon disulfide, are primarily aromatic in nature, but may also be identified as containing varying amounts of sulfur, oxygen, and nitrogen.

These asphalt and asphaltene components cause varying degrees of difficulties in various processes which are aimed at recovering crude oils and preparing them for either transportation through pipelines, or in the refining, separation, or other processes required to recover valuable products from crude oil. In fact, these asphalt and asphaltene components often cause difficulty by precipitating or fouling pumps installed underground for the purpose of recovering these crude oils. Asphaltenes are also known to foul metallic heat transfer surfaces and such fouling decreases heat transfer efficiency and clogs flow channels around or through the heat transfer equipment, heaters, and the like.

The presence of asphalts and asphaltenes in crude oil and in other fractions of petroleum cause difficulties in the recovery, transportation, treatment and refining of these crude oils and the various fractions of crude oils in which these asphalts and asphaltenes are contained.

### BRIEF SUMMARY

The present disclosure provides methods and compositions for controlling fouling. In some embodiments, a method of controlling fouling comprises adding an effective amount of an antifoulant composition to a medium, wherein the antifoulant composition comprises from about 30 wt. % to about 99 wt. % of a polyisobutylene (PIB) derivative and about 1 wt. % to about 50 wt. % of a dialkyl dithiophosphate metal salt.

In some embodiments, the method further comprises dispersing an asphaltene in the medium.

In certain embodiments, the composition comprises from about 50 wt. % to about 90 wt. % of the PIB derivative and about 10 wt. % to about 50 wt. % of the dialkyl dithiophosphate metal salt.

In some embodiments, the PIB derivative is a PIB imide. In some embodiments, the PIB imide comprises a structure selected from:

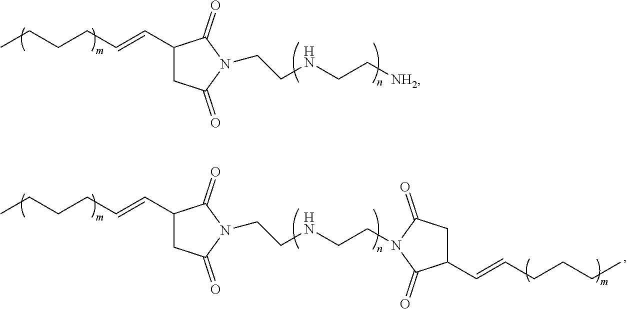

and any combination thereof, wherein each m and n are independently selected from an integer ranging from 0 to 100.

In certain embodiments, the PIB derivative has a weight average molecular weight between about 500 amu and about 4,200 amu.

In some embodiments, the dialkyl dithiophosphate metal salt is selected from the group consisting of zinc dialkyl dithiophosphate (ZDDP), molybdenum dialkyl dithiophosphate (MoDDP), and any combination thereof.

In some embodiments, the ZDDP comprises the following structure:

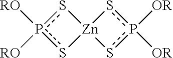

wherein each R is independently selected from a C₁-C₂₀ alkyl group.

In certain embodiments, the MoDDP comprises the following structure:

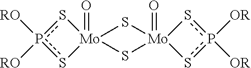

wherein each R is independently selected from a C₁-C₂₀ alkyl group.

In some embodiments, the effective amount is from about 1 ppm to about 50,000 ppm.

In some embodiments, the composition consists of or consists essentially of the PIB derivative and the dialkyl dithiophosphate metal salt.

In certain embodiments, the medium is selected from the group consisting of a petroleum product, crude oil, a hydrocarbon feedstock, a hydrocarbon stream, slop oil, heavy residua, atmospheric or vacuum residua, shale oil, liquified coal and tar sand effluent, and any combination thereof.

In some embodiments, the method is carried out in a crude unit, a coker unit, a visbreaker unit, and any combination thereof.

The present disclosure also provides compositions for controlling fouling. In some embodiments, the disclosure provides an antifoulant composition comprising about 30 wt. % to about 99 wt. % of a PIB derivative and about 1 wt. % to about 50 wt. % of a dialkyl dithiophosphate metal salt.

In some embodiments, the composition comprises from about 50 wt. % to about 90 wt. % of the PIB derivative and about 10 wt. % to about 50 wt. % of the dialkyl dithiophosphate metal salt.

In certain embodiments, the PIB derivative is a PIB imide.

In some embodiments, the PIB imide comprises a structure selected from:

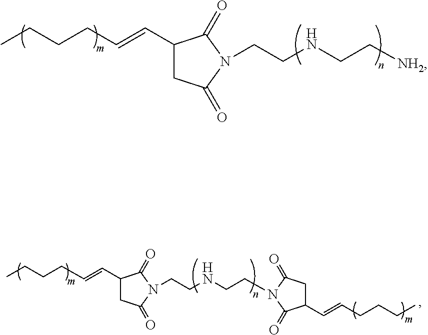

and any combination thereof, wherein each m and n are independently selected from an integer ranging from 0 to 100.

In some embodiments, the PIB derivative has a weight average molecular weight between about 500 amu and about 4,200 amu.

In certain embodiments, the dialkyl dithiophosphate metal salt is selected from the group consisting of ZDDP, MoDDP, and any combination thereof.

In some embodiments, the ZDDP comprises the following structure:

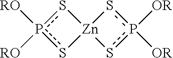

wherein each R is independently selected from a C₁-C₂₀ alkyl group.

In some embodiments, the MoDDP comprises the following structure:

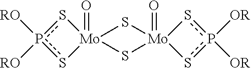

wherein each R is independently selected from a C₁-C₂₀ alkyl group.

In certain embodiments, the composition consists of or consists essentially of the PIB derivative and the dialkyl dithiophosphate metal salt.

In some embodiments, the composition further comprises a petroleum product, crude oil, a hydrocarbon feedstock, a hydrocarbon stream, slop oil, heavy residua, atmospheric or vacuum residua, shale oil, liquified coal and tar sand effluent, and any combination thereof.

The foregoing has outlined rather broadly the features and technical advantages of the present disclosure in order that the detailed description that follows may be better understood. Additional features and advantages of the disclosure will be described hereinafter that form the subject of the claims of this application.

### BRIEF DESCRIPTION OF THE SEVERAL VIEWS OF THE DRAWINGS

A detailed description of the invention is hereafter described with specific reference being made to the drawings in which:

FIG. 1 shows data from a Hot Liquid Process Simulator test using a PIB derivative, ZDDP, and a mixture of a PIB derivative and ZDDP; and

FIG. 2 shows data from a Hot Liquid Process Simulator test using a mixture of ZDDP and a PIB derivative as well as a mixture of MoDDP and a PIB derivative.

### DETAILED DESCRIPTION

Various embodiments of the present disclosure are described below. The relationship and functioning of the various elements of the embodiments may better be understood by reference to the following detailed description. However, embodiments are not strictly limited to those explicitly described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2 electrons, according to Huckel's Rule.

“Cycloalkyl” refers to a cyclic alkyl substituent containing from, for example, about 3 to about 8 carbon atoms, preferably from about 4 to about 7 carbon atoms, and more preferably from about 4 to about 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

“Heteroaryl” refers to a monocyclic or bicyclic 5- or 6-membered ring system, wherein the heteroaryl group is unsaturated and satisfies Huckel's rule. Non-limiting examples of heteroaryl groups include furanyl, thiophenyl, pyrrolyl, pyrazolyl, imidazolyl, 1,2,3-triazolyl, 1,2,4-triazolyl, isoxazolyl, oxazolyl, isothiazolyl, thiazolyl, 1,3,4-oxadiazol-2-yl, 1,2,4-oxadiazol-2-yl, 5-methyl-1,3,4-oxadiazole, 3-methyl-1,2,4-oxadiazole, pyridinyl, pyrimidinyl, pyrazinyl, triazinyl, benzofuranyl, benzothiophenyl, indolyl, quinolinyl, isoquinolinyl, benzimidazolyl, benzoxazolinyl, benzothiazolinyl, quinazolinyl, and the like.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (i.e., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino (—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co) polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The present disclosure provides antifoulant compositions and methods of using the compositions to control fouling. The term “control” in “control fouling” should be understood to mean, for example, reduce, inhibit, slow, prevent, minimize, etc. An illustrative, non-limiting example of controlling fouling includes dispersing and maintaining a dispersion of a foulant, such as an asphaltene, in a medium. This inhibits precipitation and formation of deposits on surfaces of equipment in contact with the medium. The antifoulant compositions may be used, for example, to control fouling in a pipeline and/or a hydrocarbon refinery, or a unit thereof, such as a crude unit, a coker unit, a visbreaker unit, and any combination thereof.

The antifoulant compositions disclosed herein may be added in effective amounts to crude oil, a refinery stream, a petroleum product, or a fraction thereof, in the recovery, transportation, treatment, and/or refining of these oils and products. These compositions effectively prevent fouling of, for example, heating surfaces/heat transfer surfaces in refining operations.

In accordance with the present disclosure, an antifoulant composition may include a PIB derivative and a dialkyl dithiophosphate metal salt. The PIB derivative may be selected from, for example, a PIB imide, such as a PIB succinimide.

The PIB derivative may be prepared by, for example, reacting polyisobutylene succinic anhydride (or acid) with a polyamine. Polyisobutylenesuccinic acids or the corresponding polyisobutylenesuccinic anhydride compounds are well known and any of them, such as polyisobutenyl polyethylenepolyamine succinimide, can be used in accordance with the present disclosure.

In some embodiments, the PIB derivative is derived from an isobutylene homopolymer or an isobutylene copolymer.

With respect to the polyamine, non-limiting examples include ethylene diamine, diethylene triamine, triethylene tetramine, tetraethylene pentaamine, penta-ethylene hexamine, and the like, and any combination thereof.

The resulting PIB derivative may comprise the following mono-imide structure:

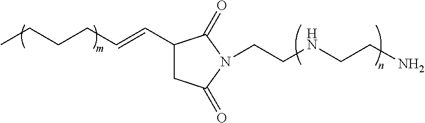

wherein m and n are each independently selected from an integer from 0 to about 100.

For example, m may be selected from about 1 to about 100, about 1 to about 90, about 1 to about 80, about 1 to about 70, about 1 to about 60, about 1 to about 50, about 1 to about 40, about 1 to about 30, about 1 to about 20, about 1 to about 10, about 1 to about 5, about 10 to about 20, about 10 to about 30, about 10 to about 40, about 10 to about 50, about 10 to about 60, about 15 to about 25, about 15 to about 35, or about 15 to about 45.

As additional examples, n may be selected from about 0 to about 20, about 0 to about 18, about 0 to about 16, about 0 to about 14, about 0 to about 12, about 0 to about 10, about 0 to about 8, about 0 to about 6, about 0 to about 4, about 0 to about 2, about 1 to about 2, about 1 to about 3, about 1 to about 4, about 1 to about 5, about 1 to about 6, about 1 to about 7, about 1 to about 8, about 1 to about 9, or about 1 to about 10.

In some embodiments, the resulting PIB derivative may comprise the following di-imide structure:

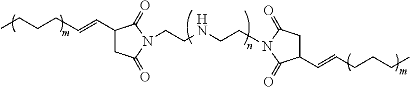

wherein m and n are each independently selected from an integer from 0 to about 100.

For example, each m may be independently selected from about 1 to about 100, about 1 to about 90, about 1 to about 80, about 1 to about 70, about 1 to about 60, about 1 to about 50, about 1 to about 40, about 1 to about 30, about 1 to about 20, about 1 to about 10, about 1 to about 5, about 10 to about 20, about 10 to about 30, about 10 to about 40, about 10 to about 50, about 10 to about 60, about 15 to about 25, about 15 to about 35, or about 15 to about 45.

As additional examples, n may be selected from about 0 to about 20, about 0 to about 18, about 0 to about 16, about 0 to about 14, about 0 to about 12, about 0 to about 10, about 0 to about 8, about 0 to about 6, about 0 to about 4, about 0 to about 2, about 1 to about 2, about 1 to about 3, about 1 to about 4, about 1 to about 5, about 1 to about 6, about 1 to about 7, about 1 to about 8, about 1 to about 9, or about 1 to about 10.

In certain embodiments, the antifoulant composition disclosed herein may comprise a mixture of:

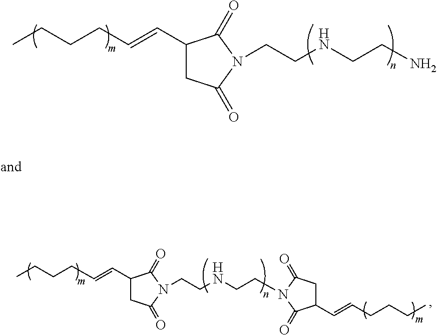

wherein m and n are as defined above.

The weight average molecular weight of the PIB derivative is not particularly limited. In some embodiments, the molecular weight is from about 500 amu to about 4,200 amu. For example, the molecular weight may be from about 500 amu to about 4,000 amu, about 500 amu to about 3,800 amu, about 500 amu to about 3,600 amu, about 500 amu to about 3,400 amu, about 500 amu to about 3,200 amu, about 500 amu to about 3,000 amu, about 500 amu to about 2,800 amu, about 500 amu to about 2,600 amu, about 500 amu to about 2,500 amu, about 500 amu to about 2,400 amu, about 500 amu to about 2,300 amu, about 500 amu to about 2,200 amu, about 500 amu to about 2, 100 amu, about 500 amu to about 2,000 amu, about 500 amu to about 1,500 amu or from about 500 amu to about 1,000 amu.

The compositions disclosed herein also include a dialkyl dithiophosphate metal salt. For example, the dialkyl dithiophosphate metal salt may be selected from ZDDP, MoDDP, or any combination thereof.

The ZDDP may comprise the following structure:

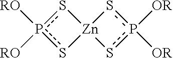

wherein each R is independently selected from a C₁-C₂₀ alkyl group. For example, each R may be independently a C₁-C₁₈ alkyl group, a C₁-C₁₆ alkyl group, a C₁-C₁₄ alkyl group, a C₁-C₁₄ alkyl group, a C₁-C₁₂ alkyl group, a C₁-C₁₀ alkyl group, a C₁-C₈ alkyl group, a C₁-C₆ alkyl group, a C₁-C₄ alkyl group, a C₅-C₂₀ alkyl group, a C₅-C₂₀ alkyl group, a C₇-C₂₀ alkyl group, a C₉-C₂₀ alkyl group, a C₁₁-C₂₀ alkyl group, a C₁₃-C₂₀ alkyl group, a C₁₅-C₂₀ alkyl group, a C₁₇-C₂₀ alkyl group, or a C₁₉-C₂₀ alkyl group.

In some embodiments, each R is independently selected from isooctyl, ethyl, butyl or aryl.

The MoDDP may comprise the following structure:

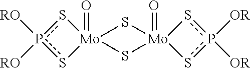

wherein each R is independently selected from a C₁-C₂₀ alkyl group. For example, each R may be independently a C₁-C₁₈ alkyl group, a C₁-C₁₆ alkyl group, a C₁-C₁₄ alkyl group, a C₁-C₁₄ alkyl group, a C₁-C₁₂ alkyl group, a C₁-C₁₀ alkyl group, a C₁-C₈ alkyl group, a C₁-C₆ alkyl group, a C₁-C₄ alkyl group, a C₅-C₂₀ alkyl group, a C₅-C₂₀ alkyl group, a C₇-C₂₀ alkyl group, a C₉-C₂₀ alkyl group, a C₁₁-C₂₀ alkyl group, a C₁₃-C₂₀ alkyl group, a C₁₅-C₂₀ alkyl group, a C₁₇-C₂₀ alkyl group, or a C₁₉-C₂₀ alkyl group.

In some embodiments, each R is independently selected from isooctyl, ethyl, butyl or aryl.

The antifoulant composition may comprise varying amounts of the PIB derivative and the dialkyl dithiophosphate metal salt. For example, the composition may comprise from about 30 wt. % to about 99 wt. % of the PIB derivative and about 1 wt. % to about 50 wt. % of the dialkyl dithiophosphate metal salt.

In accordance with certain aspects of the present disclosure, the composition may comprise from about 40 wt. % to about 95 wt. % of the PIB derivative, about 40 wt. % to about 90 wt. % of the PIB derivative, about 40 wt. % to about 85 wt. % of the PIB derivative, about 40 wt. % to about 80 wt. % of the PIB derivative, about 45 wt. % to about 90 wt. % of the PIB derivative, about 45 wt. % to about 85 wt. % of the PIB derivative, about 45 wt. % to about 80 wt. % of the PIB derivative, about 50 wt. % to about 90 wt. % of the PIB derivative, about 60 wt. % to about 85 wt. % of the PIB derivative, or about 70 wt. % to about 80 wt. % of the PIB derivative.

In accordance with certain aspects of the present disclosure, the composition may comprise from about 10 wt. % to about 50 wt. % of the dialkyl dithiophosphate metal salt, such as from about 10 wt. % to about 40 wt. %, about 10 wt. % to about 30 wt. %, about 10 wt. % to about 20 wt. %, about 15 wt. % to about 30 wt. %, about 15 wt. % to about 25 wt. %, about 15 wt. % to about 20 wt. %, about 20 wt. % to about 30 wt. %, or about 20 wt. % to about 25 wt. % of the dialkyl dithiophosphate metal salt.

The antifoulant compositions disclosed herein may include additional additives, such as nonyl phenol formaldehyde resin, PIBSA, pentaerythritol ester, and any combination thereof.

The antifoulant compositions disclosed herein may include from about 0 wt. % to about 50 wt. % of the additional additives, such as from about 1 wt. % to about 40 wt. %, about 1 wt. % to about 30 wt. %, about 1 wt. % to about 25 wt. %, about 1 wt. % to about 20 wt. %, about 1 wt. % to about 15 wt. %, about 1 wt. % to about 10 wt. %, or about 1 wt. % to about 5 wt. % of the additional additives.

In some embodiments, the antifoulant compositions disclosed herein may consist of or consist essentially of the PIB derivative and the dialkyl dithiophosphate metal salt. If the composition consists essentially of the PIB derivative and the dialkyl dithiophosphate metal salt, it excludes other components that affect the basic and novel characteristics of the composition, such as polycondensed aromatic/-naphthenic compounds, such as those having thiophenic structures.

The compositions disclosed herein may be used in methods for controlling fouling of a surface of a component used in a hydrocarbon refinery, wherein the surface is exposed to a medium comprising a foulant or foulant precursor. The foulant and/or foulant precursor may include, for example, an asphaltene, a paraffin, a wax, a scale, a naphthenate, coke, or any combination thereof. The compositions may be added to the medium and/or to the surface of the component in an amount that can effectively control fouling. In some embodiments, controlling fouling includes dispersing the foulant and/or keeping the foulant dispersed in the medium so it cannot deposit on a surface in contact with the medium.

In the disclosed methods, the component of the refinery may comprise a part of a storage unit, a heat exchanger, a pipe, a pump, a flow meter, a valve, a desalter, a furnace, a coker, a distillation column, a fractionation column, an atmospheric column, a pipe still, a debutanizer, a reactor, a fluid catalytic cracking unit, a fluid catalytic cracking slurry settler, a hydrocracking unit, a steam cracking unit, a thermal cracking unit, a visbreaker, a reflux unit, a condenser, a scrubber, or any combination thereof.

For example, the component and/or surface thereof can comprise part of a heat exchanger, a crude furnace, a crude processing unit, a coker unit, a visbreaker unit, or a combination thereof.

In the methods for controlling fouling disclosed herein, the effective amount of the antifoulant composition to be added to the medium is from about 1 ppm to about 50,000 ppm, based on the total amount of fluid, such as from about 1 ppm to about 40,000 ppm, from about 1 ppm to about 30,000 ppm, from about 1 ppm to about 20,000 ppm, from about 1 ppm to about 10,000 ppm, from about 1 ppm to about 7,500 ppm, from about 1 ppm to about 5,000 ppm, from about 1 ppm to about 2,500 ppm, from about 1 ppm to about 2,000 ppm, from about 1 ppm to about 1,500 ppm, from about 1 ppm to about 1,000 ppm, from about 1 ppm to about 500 ppm, from about 1 ppm to about 100 ppm, from about 100 ppm to about 10,000 ppm, from about 500 ppm to about 10,000 ppm, from about 1,000 ppm to about 10,000 ppm, or from about 5,000 ppm to about 10,000 ppm.

A medium as disclosed herein may include, for example, a petroleum product, crude oil, a hydrocarbon feedstock, a hydrocarbon stream, slop oil, heavy residua, atmospheric or vacuum residua, shale oil, liquified coal and tar sand effluent, and the like, and any blend thereof.

The methods and compositions disclosed herein are effective for controlling fouling in a refinery component, such as heat transfer equipment, used in a hydrocarbon refinery operation, wherein a medium of the operation, which could be a hydrocarbon, for example, may be at an elevated temperature and in fluid communication with the refinery component during operation of the refinery.

The foregoing may be better understood by reference to the following examples, which are intended for illustrative purposes and are not intended to limit the scope of the disclosure or its application in any way.

### EXAMPLES

Performance of an antifoulant composition of the present disclosure was evaluated using Hot Liquid Process Simulator (HLPS) and compared with the PIB derivative (polyisobutenyl succinimide—in heavy aromatic naphtha and mineral oil) and ZDDP (20% in mineral oil) by themselves. The antifoulant composition of the present disclosure, which comprised about 80 wt. % of the PIB derivative and about 20 wt. % ZDDP, displayed unexpected synergy. The results are further discussed below.

HLPS is an industry accepted test method to evaluate antifoulant chemistry performance. In this test, a desalted crude oil is used. The test conditions employed are as follows: (a) Rod Temperature: 400° C.; Flow Rate: 1 mL/min; Pressure: 650 psi; and Reaction time: 180 min.

In the HLPS test, a homogenized crude oil sample is passed through a heated zone at a given flow rate. During this test, the inlet, outlet, and the rod temperatures are measured and recorded. The foulant precursors are destabilized while passing through the heated zone and tend to precipitate and stick to the heated rod, resulting in reduced outlet temperature. The test is repeated with antifoulant-dosed-desalted crude. Then, the fouling curves from these tests are compared for a performance improvement.

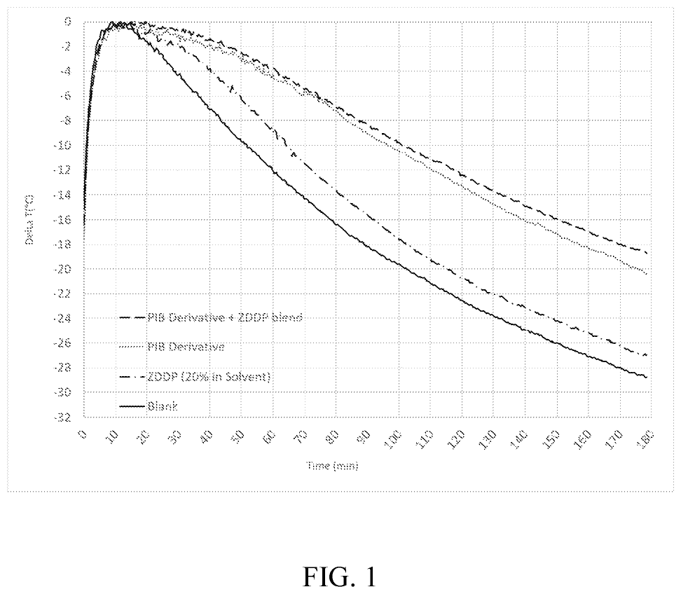

As can be seen in FIG. 1, the composition comprising the PIB derivative and ZDDP outperformed both the ZDDP alone, the PIB derivative alone, and the blank. Moreover, the composition displayed unexpected synergy. If one of ordinary skill in the art were to review the results of the PIB derivative by itself and the ZDDP by itself, he or she would not expect that the mixture of the two would outperform the PIB derivative. Instead, it would be expected that the performance of the composition would fall between the PIB derivative and the ZDDP.

Each antifoulant was dosed into the crude oil at about 100 ppm. For example, when the PIB derivative was tested alone, it was added to the oil at a concentration of about 100 ppm, when the ZDDP was tested alone, it was added to the oil at a concentration of about 100 ppm, and when the composition comprising the PIB derivative and ZDDP was added to the oil, it was added at a concentration of about 100 ppm.

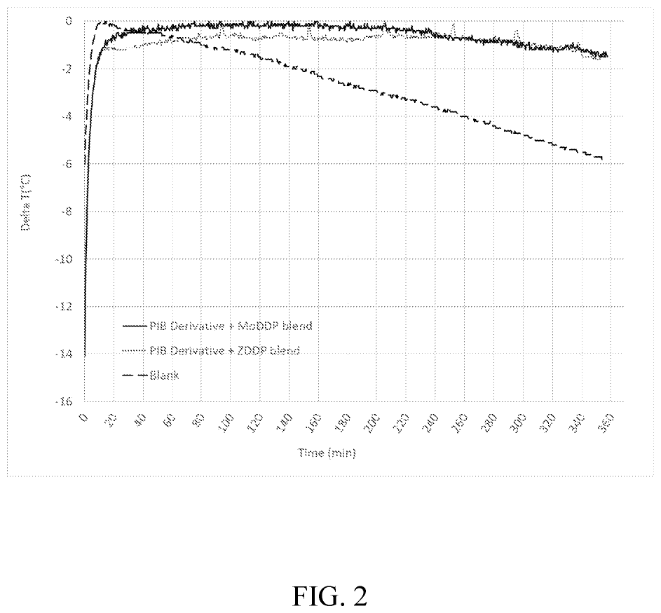

FIG. 2 shows the results of a similar test except that a composition comprising a PIB derivative and ZDDP was tested as well as a composition comprising a PIB derivative and MoDDP. As can be seen in the figure, performance was similar between the two mixtures, indicating that the mixture comprising MoDDP also displays a synergistic effect.

The first composition included about 80 wt. % of the PIB derivative and about 20 wt. % of the ZDDP. The second composition included about 95 wt. % of the PIB derivative and about 5 wt. % of the MoDDP. Each composition was dosed into the oil at about 100 ppm.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a PIB derivative” is intended to include “at least one PIB derivative” or “one or more PIB derivatives.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of inhibiting fouling, comprising:
adding an effective amount of an antifoulant composition to a medium, wherein the antifoulant composition comprises from about 30 wt. % to about 99 wt. % of a polyisobutylene (PIB) derivative and about 1 wt. % to about 50 wt. % of a dialkyl dithiophosphate metal salt.

2. The method of claim 1, further comprising dispersing an asphaltene in the medium.

3. The method of claim 1, wherein the composition comprises from about 50 wt. % to about 90 wt. % of the PIB derivative and about 10 wt. % to about 50 wt. % of the dialkyl dithiophosphate metal salt.

4. The method of claim 1, wherein the PIB derivative is a PIB imide.

5. The method of claim 4, wherein the PIB imide comprises a structure selected from: 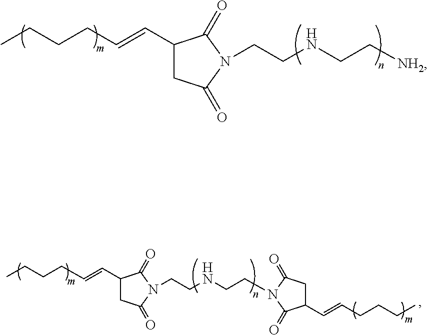
and any combination thereof, wherein each m and n are independently selected from an integer ranging from 0 to 100.

6. The method of claim 1, wherein the PIB derivative has a weight average molecular weight between about 500 amu and about 4,200 amu.

7. The method of claim 1, wherein the dialkyl dithiophosphate metal salt is selected from the group consisting of zinc dialkyl dithiophosphate (ZDDP), molybdenum dialkyl dithiophosphate (MoDDP), and any combination thereof.

8. The method of claim 7, wherein the ZDDP comprises the following structure: 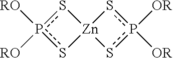
wherein each R is independently selected from a C₁-C₂₀ alkyl group.

9. The method of claim 7, wherein the MoDDP comprises the following structure: 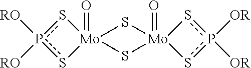
wherein each R is independently selected from a C₁-C₂₀ alkyl group.

10. The method of claim 1, wherein the effective amount is from about 1 ppm to about 50,000 ppm.

11. The method of claim 1, wherein the composition consists of or consists essentially of the PIB derivative and the dialkyl dithiophosphate metal salt.

12. The method of claim 1, wherein the medium is selected from the group consisting of a petroleum product, crude oil, a hydrocarbon feedstock, a hydrocarbon stream, slop oil, heavy residua, atmospheric or vacuum residua, shale oil, liquified coal and tar sand effluent, and any combination thereof.

13. The method of claim 1, wherein the method is carried out in a crude unit, a coker unit, a visbreaker unit, and any combination thereof.

14. An antifoulant composition, comprising:
about 30 wt. % to about 99 wt. % of a PIB derivative and about 1 wt. % to about 50 wt. % of a dialkyl dithiophosphate metal salt.

15. The composition of claim 14, wherein the composition comprises from about 50 wt. % to about 90 wt. % of the PIB derivative and about 10 wt. % to about 50 wt. % of the dialkyl dithiophosphate metal salt.

16. The composition of claim 14, wherein the PIB derivative is a PIB imide.

17. The composition of claim 16, wherein the PIB imide comprises a structure selected from: 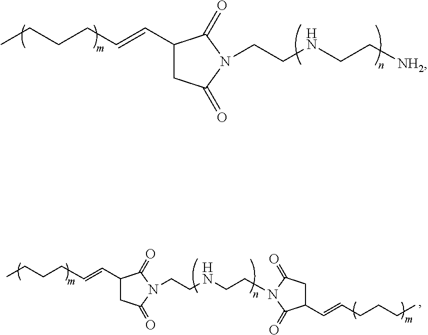
and any combination thereof, wherein each m and n are independently selected from an integer ranging from 0 to 100.

18. The composition of claim 14, wherein the dialkyl dithiophosphate metal salt is selected from the group consisting of ZDDP, MoDDP, and any combination thereof.

19. The composition of claim 18, wherein the ZDDP comprises the following structure: 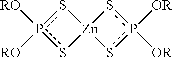
wherein each R is independently selected from a C₁-C₂₀ alkyl group.

20. The composition of claim 14, wherein the composition consists of or consists essentially of the PIB derivative and the dialkyl dithiophosphate metal salt.
